(19) United States
(12) Patent Application Publication
(10) Pub. No.: US 2015/0019367 A1
(43) Pub. Date: Jan. 15, 2015

(54) Generating a Product with an Invoice Simulation Product Builder

(71) Applicant: MetraTech Corp., Waltham, MA (US)

(72) Inventors: Kenton A. Kline, Waltham, MA (US); Jason Mondanaro, Waltham, MA (US); Mario DeSousa, Waltham, MA (US)

(21) Appl. No.: 13/932,708

(22) Filed: Jul. 1, 2013

(51) Int. Cl. G06Q 30/06

(52) U.S. Cl. CPC G06Q 30/0621
USPC 705/26.5

(57) ABSTRACT

A method includes accessing information indicative of an invoice simulation product builder for generating a product, with the invoice simulation product builder comprising a plurality of graphical user interfaces, with at least one of the graphical user interfaces, when rendered on a display device, comprising: a visual representation of a product invoice template for the product being generated with the invoice simulation product builder, with the invoice simulation product builder promoting generation of the product by adding one or more features to the product invoice template; transmitting the information indicative of the invoice simulation product builder; receiving information indicative of a selection in the product invoice template of features of the product; causing the product invoice template to be updated to display a simulation of an invoice that includes the selected features for the product; and adding the selected features to the product.

### BACKGROUND

In an example, a product includes a service that is offered for sale, a service plan (hereinafter a plan) that is offered for sale, an item that is offered for sale, a collection of one or more services, plans and/or items that are offered for sale, or any combination thereof. There are various types of services, including, e.g., telephony services, mobile device services, Internet services, data services, or any combination thereof.

### SUMMARY

In one aspect of the present disclosure, a method includes accessing, by a server computing device, information indicative of an invoice simulation product builder for generating a product, with the invoice simulation product builder comprising a plurality of graphical user interfaces, with at least one of the graphical user interfaces, when rendered on a display device, comprising: a visual representation of a product invoice template for the product being generated with the invoice simulation product builder, with the invoice simulation product builder promoting generation of the product by adding one or more features to the product invoice template, and with the product invoice template comprising a simulation of an invoice for the product being generated with the invoice simulation product builder; transmitting, to a client computing device, the information indicative of the invoice simulation product builder; receiving, from the client computing device, information indicative of a selection in the product invoice template of features of the product; causing the product invoice template to be updated to display a simulation of an invoice that includes the selected features for the product; and adding the selected features to the product.

Implementations of the disclosure may include one or more of the following features. In some implementations, a first one of the features comprises a predefined product that is offered for sale; and a second one of the features comprises one or more of a charge model, the charge model comprises one or more of: a recurring charge model; and a one-time charge model; a third one of the features comprises: a usage model for the predefined product, with a usage model specifying one or more instructions for detecting when consumer use of a product is billed to the predefined product; and a fourth one of the features comprises: a pricing model for the predefined product, with the pricing model comprising information indicative of an amount charged for use of a product included in the predefined product. In still other implementations, adding the selected features to the product comprises: adding the predefined product to the product that is generated with the invoice simulation product builder; adding the charge model to the product that is generated with the invoice simulation product builder; generating an association between the predefined product and the charge model; adding the usage model to the product that is generated with the invoice simulation product builder; generating an association between the predefined product and the usage model; adding the pricing model to the product that is generated with the invoice simulation product builder; and generating an association between the predefined product and the pricing model.

In still other implementations, the method includes receiving, from the client computing device, information indicative of one or more modifications to the pricing model for the predefined product; and updating the pricing model for the predefined product that is included in the product that is generated with the invoice simulation product builder, with updating being in accordance with the one or more modifications. In yet other implementations, the method includes receiving, from the client computing device, information indicative of a name of the product that is generated with the invoice simulation product builder; assigning, in a data repository, the information indicative of the name of the product to information that identifies the product.

In still other implementations, the method includes storing, in a data repository, information indicative of the product that is generated with the invoice simulation product builder. In still other implementations, the method includes assigning information indicative of the product that is generated with the invoice simulation product builder to information indicative of a product catalog, with a product catalog comprising at least a plurality of products that are available for purchase by one or more consumers. In some implementations, the product that is generated with the invoice simulation product builder comprises one or more of: a telephony product, a data product, and an internet product.

In another aspect of the disclosure, one or more machine-readable storage media are configured to store instructions for causing one or more processing devices to perform operations comprising: accessing information indicative of an invoice simulation product builder for generating a product, with the invoice simulation product builder comprising a plurality of graphical user interfaces, with at least one of the graphical user interfaces, when rendered on a display device, comprising: a visual representation of a product invoice template for the product being generated with the invoice simulation product builder, with the invoice simulation product builder promoting generation of the product by adding one or more features to the product invoice template, and with the product invoice template comprising a simulation of an invoice for the product being generated with the invoice simulation product builder; transmitting, to a client computing device, the information indicative of the invoice simulation product builder; receiving, from the client computing device, information indicative of a selection in the product invoice template of features of the product; causing the product invoice template to be updated to display a simulation of an invoice that includes the selected features for the product; and adding the selected features to the product. Implementations of this aspect of the present disclosure can include one or more of the foregoing features.

In still another aspect of the disclosure, a system includes one or more processing devices; and one or more machine-readable media configured to store instructions that are executable to cause the one or more processing devices to perform operations comprising: accessing information indicative of an invoice simulation product builder for generating a product, with the invoice simulation product builder comprising a plurality of graphical user interfaces, with at least one of the graphical user interfaces, when rendered on a display device, comprising: a visual representation of a product invoice template for the product being generated with the invoice simulation product builder, with the invoice simulation product builder promoting generation of the product by adding one or more features to the product invoice template, and with the product invoice template comprising a simulation of an invoice for the product being generated with the invoice simulation product builder; transmitting, to a client computing device, the information indicative of the invoice simulation product builder; receiving, from the client computing device, information indicative of a selection in the product invoice template of features of the product; causing the product invoice template to be updated to display a simulation of an invoice that includes the selected features for the product; and adding the selected features to the product. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages will be apparent from the description and drawings, and from the claims.

### BRIEF DESCRIPTION OF THE FIGURES

FIGS. 1-9 are screen shots of graphical user interfaces for use in generating a product with an invoice simulation product builder.

FIG. 10 is a network environment for generating a product with an invoice simulation product builder.

FIG. 11 is a block diagram showing examples of components used in the network environment for generating a product with an invoice simulation product builder.

FIG. 12 is a flowchart of a process for generating a product with an invoice simulation product builder.

### DETAILED DESCRIPTION

A system consistent with this disclosure generates a product with an invoice simulation product builder. The invoice simulation product builder is a computer program (e.g., a web accessible computer program) that enables a user to build a product. The invoice simulation product builder displays a product invoice template. Generally, a product invoice template includes a visualization of a simulated invoice. For example, the simulated invoice may be for the product being generated with the invoice simulation product builder. The invoice simulation product builder enables the user to build the product by adding features (to be included in the product) to the product invoice template. Generally, a feature includes an attribute and/or a quality of a product. There are various types of features, including, e.g., other products to be included in a product being built, prices of products, charge cycles for products, usage models for products, and so forth.

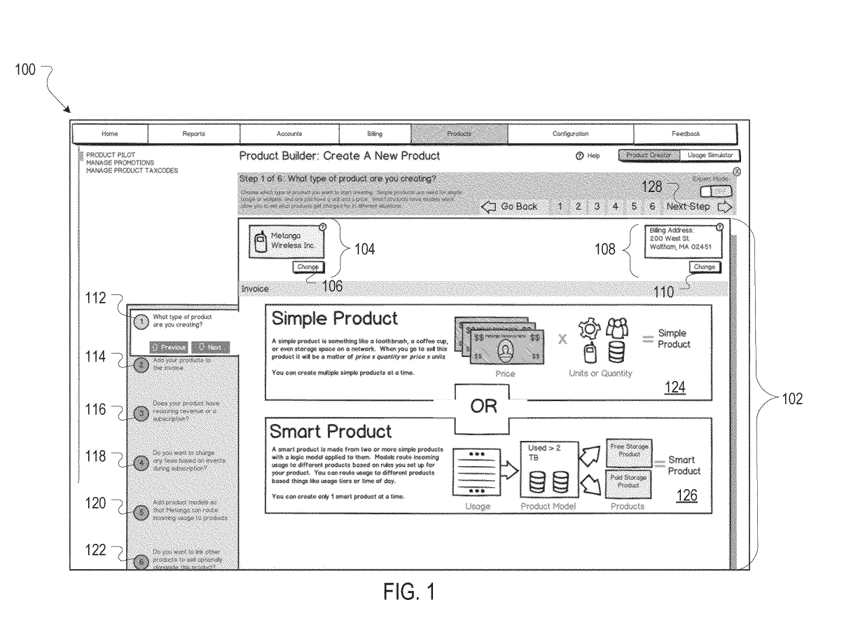

Referring to FIG. 1, an invoice simulation product builder (not shown) causes a display of product builder interface 100 on a client device (not shown). A product builder interface is a graphical user interface. Product builder interface 100 includes product invoice template 102 into which features of a product may be added and used in generating the product. Product invoice template 102 includes service provider portion 104, e.g., for display of information specifying a service provider that is providing the product to be generated through the invoice simulation product builder. The information displayed in service provider portion 104 is editable, e.g., upon selection of control 106. Product invoice template 102 includes customer portion 108, e.g., for display of information specifying a customer who is being invoiced for the product generated through the invoice simulation product builder. The information displayed in service customer portion 108 is editable, e.g., upon selection of control 110.

The process of using the invoice simulation product builder to build a product includes various stages, e.g., as represented by stage information 112, 114, 116, 118, 120, 122. In this example, stage information 112 represents a product selection stage, in which a user selects a type of product to be generated through the invoice simulation product builder. There are various types of products, including, e.g., simple products and smart products, as described in further detail below. Stage information 114 represents a feature selection stage in which features are added to a product invoice template. Stage information 116 represents a charge model stage in which a charge model is associated with the product generated through the invoice simulation product builder. Generally, a charge model specifies a frequency with which a consumer is invoiced for use of a product.

Product builder interface 100 also displays stage information 118, which represents a fee addition stage. In the fee addition stage, a user of the invoice simulation product builder may select one or more fees for various events that are associated with the product. Stage information 120 represents a usage model stage for selection a usage model. A usage model specifies one or more instructions for detecting when consumer use of a product is billed to a product. Stage information 122 represents a link stage, in which a user may associate (e.g., link) other products to the product that is generated through the invoice simulation product builder. Through the association among the products, a consumer is presented with the generated product and the other, associated product, e.g., when viewing products for purchase.

In the product selection stage (represented by stage information 112), there are various types of products, e.g., simple products and smart products. Generally, a simple product includes a product for which a specified quantity (and/or a specified number of units) is sold at a specified price. Generally, a smart product includes a grouping of two or more simple products and a logic model that may be applied to the grouping. In this example, the logic model includes a series of rules for using usage data in selecting which products are used in invoicing a customer. Generally, usage data includes data indicative of an amount of usage of a particular service, e.g., a data service, a telephony service, and so forth.

In the example of FIG. 1, simple product information 124 represents a simple product. A user may select simple product information 124 to specify that the user wants to use a simple product in generating a product with the invoice simulation product builder. Upon selection of simple product information 124 (and/or a portion of simple product information 124), the user is presented with a series of animated graphical user interfaces for the input of price information and quantity information to be used in generating the simple product.

In the example of FIG. 1, smart product information 126 represents a smart product. A user may select smart product information 126 (and/or a portion thereof) to specify that the user wants to use a smart product in generating a product with the invoice simulation product builder. Upon selection of smart product information 126 (and/or a portion of thereof), the invoice simulation product builder guides the user through the various stages in building a product, e.g., by adding features to the product. In this example, a user of the invoice simulation product builder completes the product selection stage and selects next stage control 128, e.g., to move to the feature selection stage.

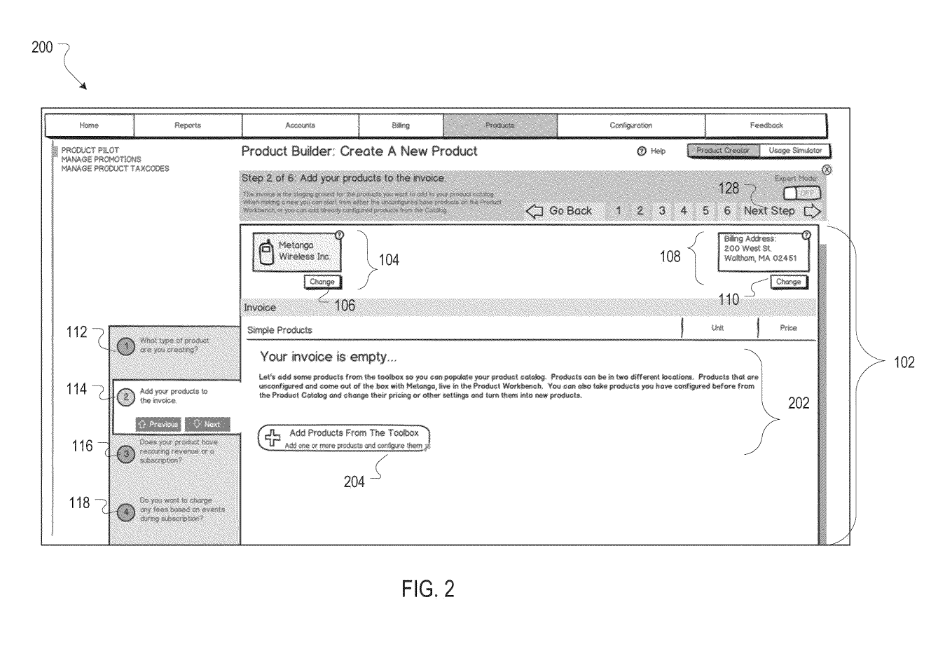

Referring to FIG. 2, product builder interface 200 is displayed at the feature selection stage, e.g., as indicated by stage information 114. In the example of FIG. 2, product invoice template 102 displays message 202 indicating that product invoice template 102 does not include one or more products (e.g., simple products). Product invoice template 102 also displays toolbox control 204, selection of which causes display of a toolbox (e.g., an interface for selecting products for inclusion in product invoice template 102).

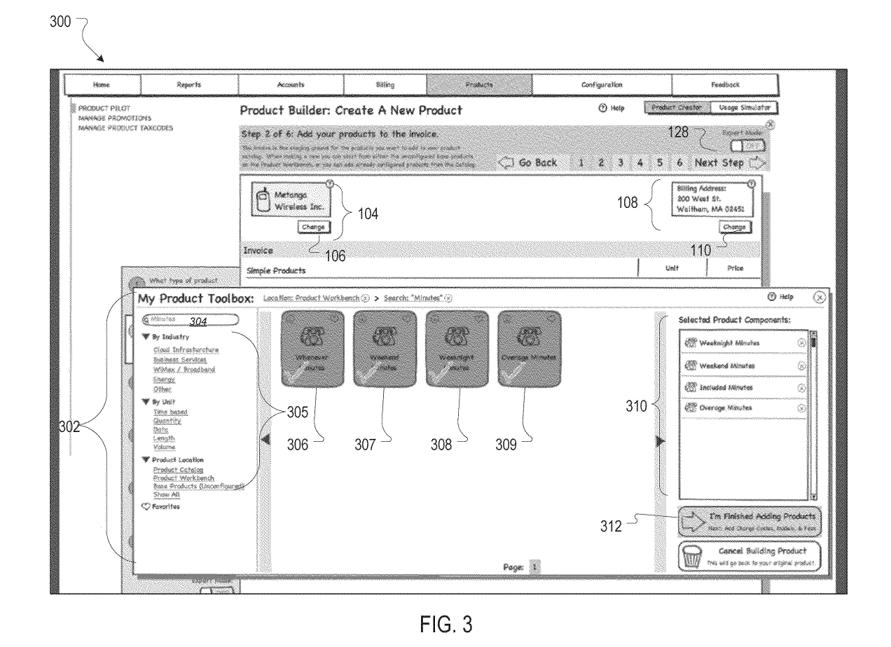

Referring to FIG. 3, product builder interface 300 is also displayed at the feature selection stage, e.g., following selection of toolbox control 204 (FIG. 2). Product builder interface 300 displays toolbox 302 for adding one or more predefined products (e.g., simple products) to product invoice template 102 (FIG. 2). In this example, toolbox 302 includes search box 304 for entry of one or more search terms to be used in identify predefined products. Toolbox 302 also includes selectable links 305 for searching for predefined products in various categories.

In the example of FIG. 3, a user enters the search term “minutes” into search box 304. In response, toolbox 302 displays product information 306, 307, 308, 309 indicative of various, different products with attributes that at least partially match the entered search terms. Product information 306 represents a product for peek time minutes of telephonic usage. Product information 307 represents a product for weekend minutes of telephonic usage. Product information 308 represents a product for weeknight minutes of telephonic usage. Product information 309 represents a product for overage minutes of telephonic usage. One or more of product information 306, 307, 308, 309 may be selectable, selection of which adds a product represented by the selected product information to product invoice template 102. In the example of FIG. 3, a user has selected product information 306, 307, 308, 309. Toolbox 302 also includes portion 310 for a display of a listing of the products that have been selected for inclusion in product invoice template 102. Toolbox 302 includes completion control 312, selection of which specifies that the user is finished adding predefined products to product invoice template 102.

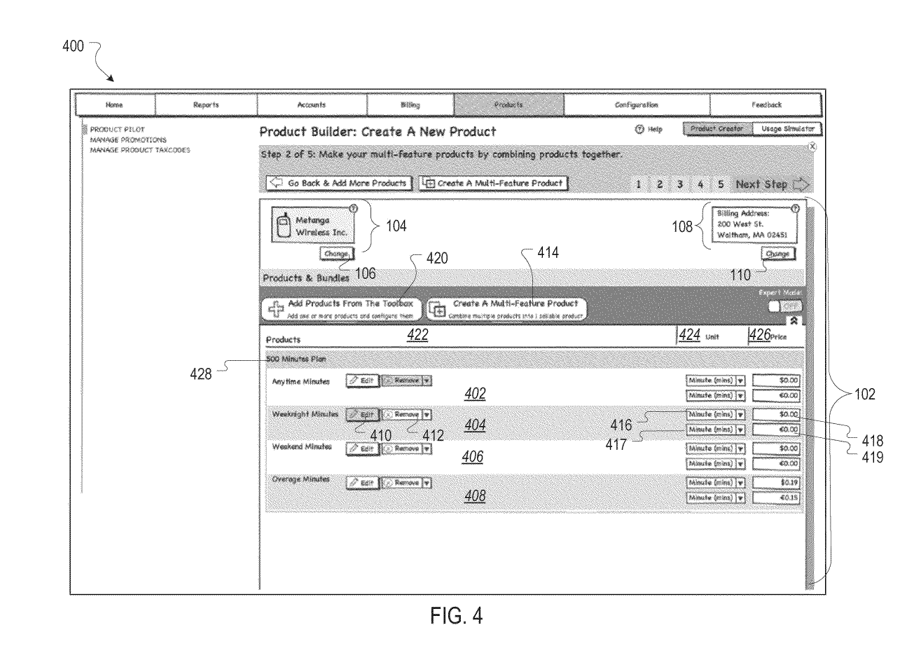

Referring to FIG. 4, product builder interface 400 is also displayed at the feature selection stage, e.g., following selection of completion control 312 (FIG. 3). Product builder interface 400 includes toolbox control 420, selection of which displays a toolbox (e.g., toolbox 302 in FIG. 3) for a user to select products to be included in product invoice template 102. Product builder interface 400 also includes multi-feature product control 414 to enable generation of a multi-feature product. Generally, a multi-feature product combines various individual products into a sellable product (e.g., a plan). Generally, a plan includes a collection of one or more products for a consumer to purchase together, e.g., rather than a consumer purchasing the products individually. In this example, a user selects multi-feature product control 414 to include the products selected via product information 306, 307, 308, 309 (FIG. 3) in a plan (e.g., the “500 minutes plan”). This plan is represented by plan information 428.

In the example of FIG. 4, product invoice template 102 provides a user with a visualization of what an invoice will look like for the product that is being built through product invoice template 102. In this example, product invoice template 102 is updated to display plan information 428 indicative of a plan that includes the selected products (e.g., the products represented by product information 306, 307, 308, 309 in FIG. 3). In this example, the plan represented by plan information 428 is a multi-feature product that includes various products.

Product invoice template 102 displays product information 422 that specifies the various products included in the plan represented in product invoice template 102. In this example, product information includes items 402, 404, 406, 408 of product information 422, which are indicative of individual products that are included in the plan shown in product invoice template 102. Product invoice template 102 displays unit information 424 that is indicative of a unit of measurement that is used in pricing the products included in the plan. In this example, unit information 424 is associated with various unit controls (e.g., unit controls 416, 417) for a user to specify a particular unit for a product. In the example of FIG. 4, the products represented by items 402, 404, 406, 408 of product information 422 are associated with minute units of measurement. Product invoice template 102 also displays pricing information 426 that is indicative of a price that is charged (per unit) for use of a product. In this example, pricing information 426 is associated with various pricing controls (e.g., pricing controls 418, 419) for a user to specify a particular price for a product.

In the example of FIG. 4, pricing controls 418, 419 are used to input pricing models that specify prices for the product represented by item 404 of product information 422. A pricing model includes information indicative of an amount charged (e.g., a price) for use of a product. In this example, pricing control 418 specifies a price in U.S. currency for the product represented by item 404 of product information 422. In this example, pricing control 419 specifies a price in European currency (i.e., the Euro) for the product represented by item 404 of product information 422. Unit control 416 is associated with pricing control 418 and specifies a unit of measurement that is used for a price specified by pricing control 418. Unit control 417 is associated with pricing control 419 and specifies a unit of measurement that is used for a price specified by pricing control 419.

In this example, product invoice template 102 also displays controls (e.g., controls 410, 412) for a user to edit and/or remove products included in the plan represented by plan information 428. In the example of FIG. 4, item 404 of product information 422 is associated with control 412, selection of which causes the system to remove, from product invoice template 102, the product represented by item 404 of product information 422. Item 404 of product information 422 is associated with control 410, selection of which enables a user to configure features of the product represented by item 404 of product information 422.

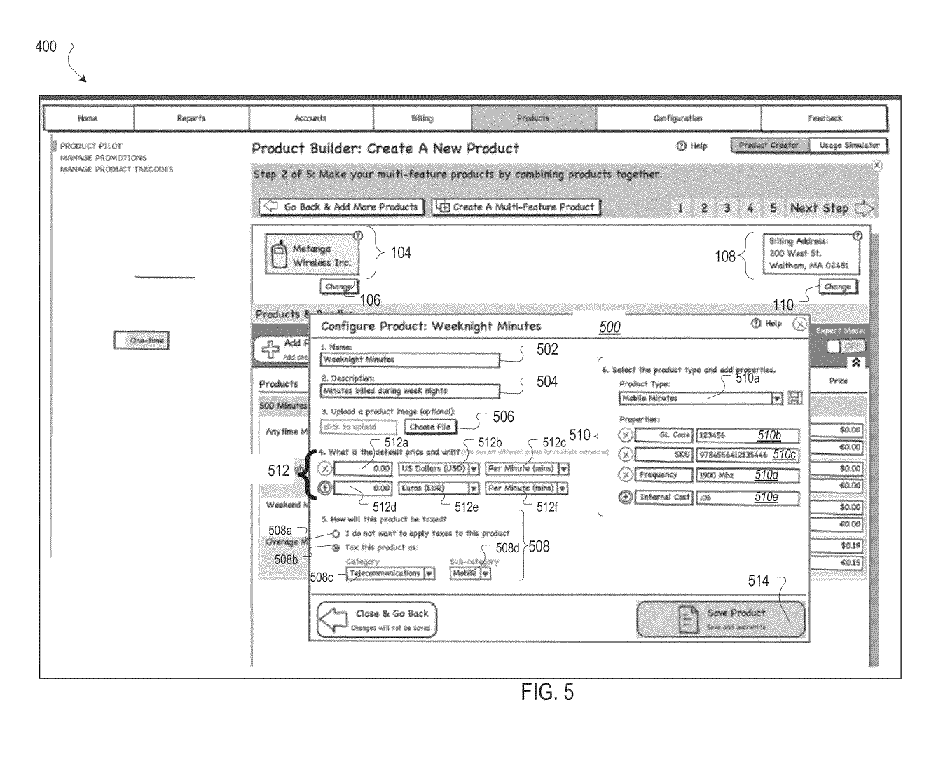

Referring to FIG. 5, overlay 500 is displayed in product builder interface 400, e.g., following selection of control 410 (FIG. 4). In this example, overlay 500 enables a user to configure features of the product represented by item 404 of product information 422 (FIG. 4). Overlay 500 includes name portion 502 for display of information specifying a name of the product represented by item 404 of product information 422. In this example, name portion 502 is editable, e.g., to enable a user to modify the name of the product represented by item 404 of product information 422.

Overlay 500 includes description portion 504 for display of information specifying a description of the product represented by item 404 of product information 422. In this example, description portion 504 is editable, e.g., to enable a user to modify the description of the product represented by item 404 of product information 422. Overlay 500 includes product image control 506 to enable a user to select an image and/or a file to be displayed in product invoice template 102. Overlay 500 includes pricing portion 512, e.g., to enable a user to select currencies, prices and units to be used in invoicing a consumer for use of the product. Pricing portion 512 includes pricing control 512a, currency control 512b and unit control 512c, e.g., for specifying a particular price in a specified currency for a particular unit of measurement for the product being configured through overlay 500. In this example, currency control 512b enables a user to select one of a plurality of currencies to be used in invoicing a customer for use of the product.

In the example of FIG. 5, the product represented by item 404 of product information 422 is invoiced in various, difference currencies (e.g., in the U.S. dollar and in the Euro). In this example, pricing control 512a, currency control 512b and unit control 512c enable a user to specify a price in U.S. dollars per minute of usage for the product being configured through overlay 500. To enable the user to price the product in another currency, pricing portion 512 includes pricing control 512d, currency control 512e and unit control 512f. In this example, the user uses pricing control 512d, currency control 512e and unit control 512e to specify a price in Euros per minute of usage for the product being configured through overlay 500. Through pricing controls, currency controls and unit controls, a user specifies default pricing information in the currencies and units that are used for billing. The default pricing information can be overridden by packages and promotions later upstream.

In this example, following input of a pricing model (e.g., into one or more of pricing controls 512a, 512d), product invoice template 102 (FIG. 4) is updated to display the simulation of the invoice that includes the input pricing models. For example, a user inputs pricing models into pricing controls 512a, 512d and product builder interface 400 is updated (not shown) to display pricing models included in pricing controls 512a, 512d.

Overlay 500 also includes tax information portion 508 for specifying how the product is taxed. Tax information portion 508 includes control 508a, selection of which specifies that the product is not taxed. Tax information portion 508 includes control 508b, selection of which specifies that the product is taxed. Control 508c enables a user to select a category (e.g., a telecommunications category) in which the product is taxed. Control 508d enables a user to select a sub-category (e.g., a mobile sub-category) in which the product is taxed.

Overlay 500 includes product type portion 510 for specifying a type for the product that is being configured through overlay 500 (e.g., the product represented by item 404 of product information 422 in FIG. 4). Product type portion 510 includes control 510a, e.g., to enable a user to select a product type for the product. Control 510a enables selection of various product types, including, e.g., a product type of mobile minutes. Product type portion 510 includes control 510b for entry for a general ledger (GL) code for the product. Product type portion 510 includes control 510c for entry for a stock keeping unit (SKU) code for the product. Product type portion 510 includes control 510d for entry of information specifying a frequency used by the product. Product type portion 510 includes control 510e for entry of information specifying an internal cost incurred by a service provider by providing the product. Overlay 500 also includes control 514, selection of which saves the information input into overlay 500 and associates the input information with the product being configured.

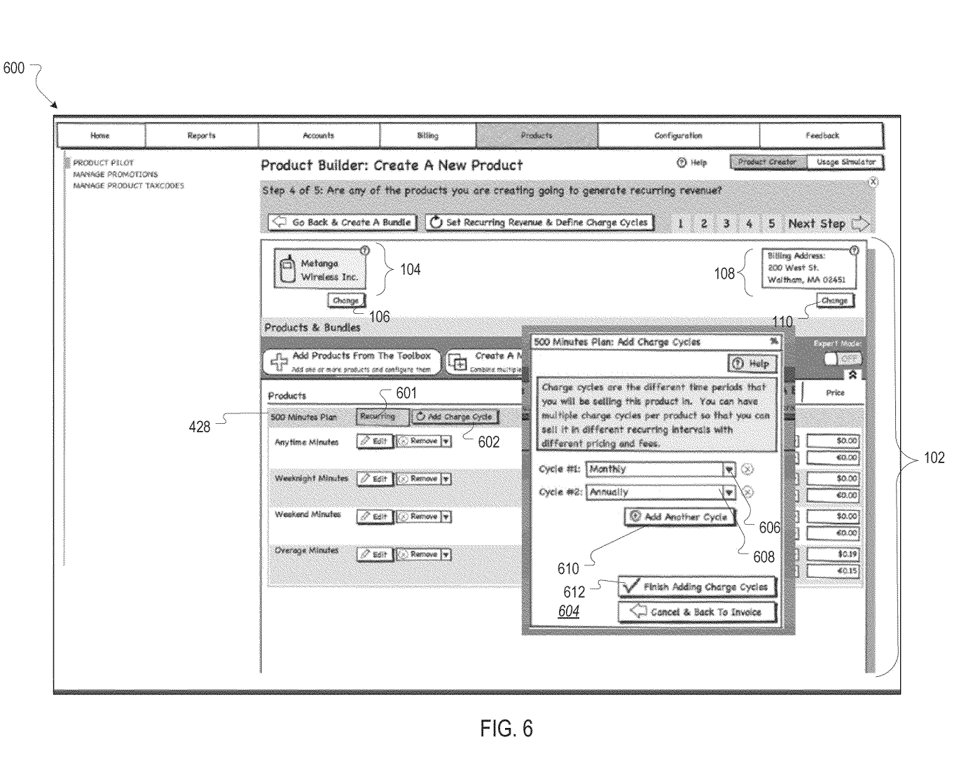

Referring to FIG. 6, product builder interface 600 is displayed, e.g., following selection of control 514 (FIG. 5). In this example, product builder interface 600 is displayed in the charge model stage, which was previously described. In the example of FIG. 6, product invoice template 102 is updated to display charge model control 601, selection of which specifies a charge model for the plan represented by plan information 428. Charge model control 601 may be toggled to select among various charge models, including, e.g., a recurring charge model and a one-time charge model. Generally, a recurring charge model includes a charge model in which a consumer is invoiced on an ongoing basis, e.g., at predetermined time intervals. Generally, a one-time charge model is a charge model in which a consumer is invoiced a single time for use of a product.

In the example of FIG. 6, a user uses charge model control 601 to select a recurring charge model. Product builder interface 600 also includes charge cycle control 602, selection of which enables a user to specify one or more charge cycles for the plan represented by plan information 428. Generally, a charge cycle includes a frequency (e.g., a time period) with which a consumer is invoiced for use of a product. Following selection of charge cycle control 602, product builder interface 600 is updated to display overlay 604 for specifying charge cycles for the plan. In this example, a plan (and/or a product) may be associated with various, different charge cycles, e.g., to promote selling of a plan at various time periods with various pricing and fee structures.

In this example, overlay 600 includes first cycle control 606 for a user to select a charge cycle (e.g., a monthly charge cycle) for the plan represented by plan information 428. Overlay 600 includes second cycle control 608 for a user to select another charge cycle (e.g., a yearly charge cycle) for the plan represented by plan information 428. Overlay 600 also includes add another cycle control 610 for a user to add yet another charge cycle to the plan represented by plan information 428. Overlay 600 includes finish control 612, selection of which specifies that a user is finished adding charge cycles to a plan.

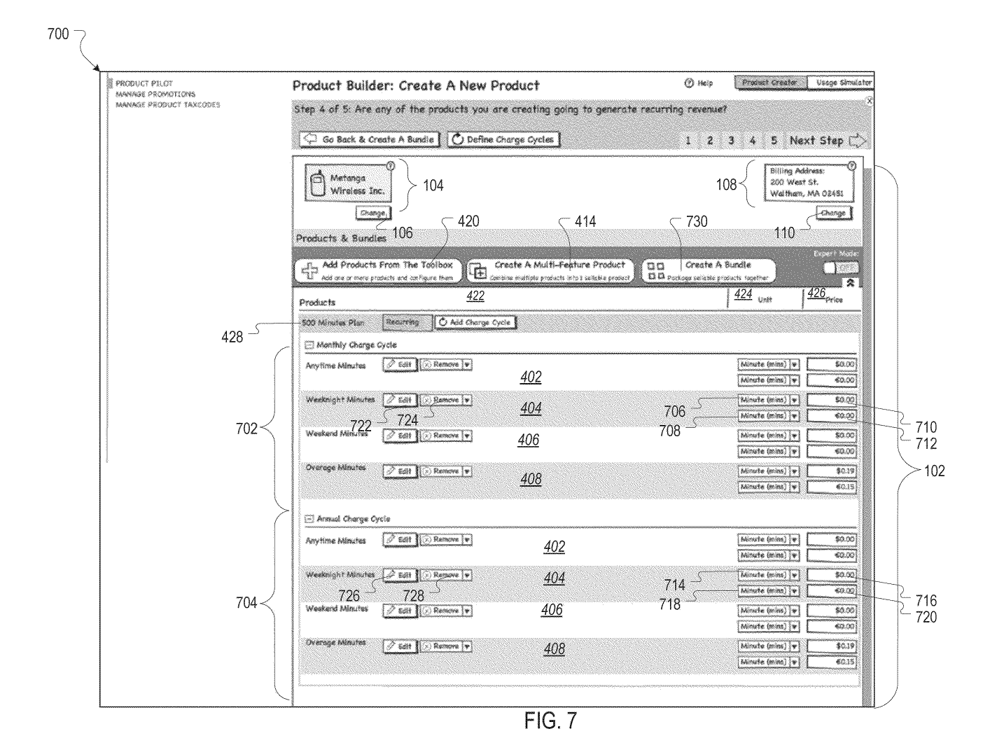

Referring to FIG. 7, product builder interface 700 is displayed, e.g., following selection of finish control 612 (FIG. 6). In this example, product invoice template 102 is updated to display charge cycle information 702, 704. Charge cycle information 702 displays information specifying one charge cycle (e.g., a monthly charge cycle) for the plan represented by plan information 428. Charge cycle information 704 displays information specifying another charge cycle (e.g., an annual charge cycle) for the plan represented by plan information 428.

Product builder interface 700 displays unit controls 706, 708, 714, 718, each of which enable a user to select a particular unit of measurement, from among various units of measurement, for a product offered in a particular charge cycle. Product builder interface 700 also displays price controls 710, 712, 716, 720, each of which enable a user to input information indicative of a particular price for a product offered in a particular charge cycle.

In this example, the charge cycle represented by charge cycle information 702 was selected through first cycle control 606 (FIG. 6) and is for a monthly charge cycle. Charge cycle information 702 specifies that a monthly charge cycle is available for a plan that includes the products represented by items 402, 404, 406, 408 of product information 422. In this example, product builder interface 700 displays unit controls 706, 708 and pricing controls 710, 712 to specify prices and units for the product represented by item 404 in the charge cycle represented by charge cycle information 702. In this example, unit controls 706, 708 specify minute units of measurement. In the charge cycle represented by charge cycle information 702, pricing control 710 specifies a price in U.S. currency for the product represented by item 404 of product information 422. In the charge cycle represented by charge cycle information 702, pricing control 712 specifies a price in European currency (i.e., the Euro) for the product represented by item 404 of product information 422. Unit control 706 is associated with pricing control 710 and specifies a unit of measurement that is used for a price specified by pricing control 710, e.g., in the charge cycle represented by charge cycle information 702. Unit control 708 is associated with pricing control 712 and specifies a unit of measurement that is used for a price specified by pricing control 712, e.g., in the charge cycle represented by charge cycle information 702.

Product builder interface 700 also displays controls (e.g., controls 722, 724) for a user to edit and/or remove, respectively, products included in the plan for the charge cycle represented by charge cycle information 702. In the example of FIG. 7, item 404 of product information 422 in the charge cycle represented by charge cycle information 702 is associated with control 724, selection of which causes the system to remove the product represented by item 404 of product information 422 from the charge cycle represented by charge cycle information 702. Item 404 of product information 422 in the charge cycle represented by charge cycle information 702 is also associated with control 722, selection of which enables a user to configure features of the product represented by item 404 of product information 422 for the charge cycle represented by charge cycle information 702.

In this example, the charge cycle represented by charge cycle information 704 is selected through second cycle control 608 (FIG. 6) and is for an annual charge cycle. Charge cycle information 704 specifies that an annual charge cycle is available for a plan that includes the products represented by items 402, 404, 406, 408 of product information 422. In this example, product builder interface 700 displays unit controls 714, 718 and pricing controls 716, 720 to specify prices and units for the product represented by item 404 in the charge cycle represented by charge cycle information 704. In this example, unit controls 714, 718 specify minute units of measurement. In the charge cycle represented by charge cycle information 704, pricing control 716 specifies a price in U.S. currency for the product represented by item 404 of product information 422. In the charge cycle represented by charge cycle information 704, pricing control 720 specifies a price in European currency (i.e., the Euro) for the product represented by item 404 of product information 422. Unit control 714 is associated with pricing control 716 and specifies a unit of measurement that is used for a price specified by pricing control 716, e.g., in the charge cycle represented by charge cycle information 704. Unit control 718 is associated with pricing control 720 and specifies a unit of measurement that is used for a price specified by pricing control 720, e.g., in the charge cycle represented by charge cycle information 704.

Product builder interface 700 also displays controls (e.g., controls 726, 728) for a user to edit and/or remove, respectively, products included in the plan for the charge cycle represented by charge cycle information 704. In the example of FIG. 7, item 404 of product information 422 for the charge cycle represented by charge cycle information 704 is associated with control 728, selection of which causes the system to remove the product represented by item 404 of product information 422 from the charge cycle represented by charge cycle information 704. Item 404 of product information 422 for the charge cycle represented by charge cycle information 704 is also associated with control 726, selection of which enables a user to configure features of the product represented by item 404 of product information 422 for the charge cycle represented by charge cycle information 704.

In the example of FIG. 7, product builder interface 700 also includes bundle control 730 for selecting one or more products and/or plans to be included in a bundle. Generally, a bundle includes a package of multiple, sellable products (e.g., multi-feature products and multiple plans).

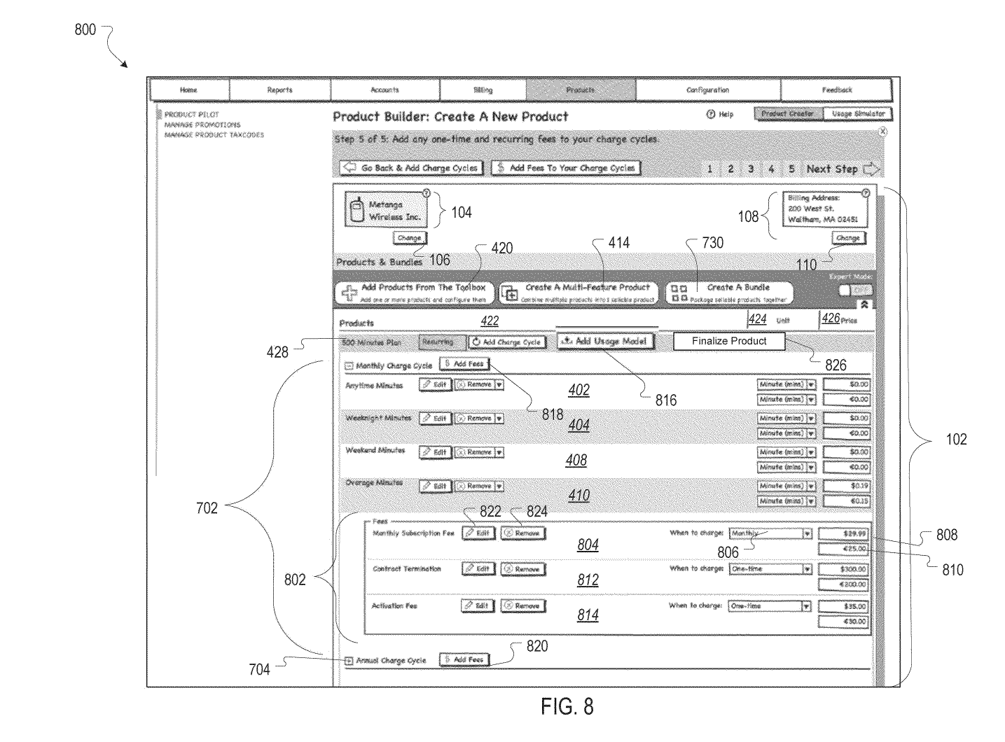

Referring to FIG. 8, product builder interface 800 is displayed at the fee addition stage. In this example, product builder interface 800 includes fee control 818, selection of which enables a user to add one or more fees to the plan that is invoiced according to the charge cycle represented by charge cycle information 702 (e.g., a monthly charge cycle). Product builder interface 800 also includes fee control 820, selection of which enables a user to add one or more fees to the plan that is invoiced according to the charge cycle represented by charge cycle information 704 (e.g., an annual charge cycle). Product builder interface 800 displays a collapsed view of charge cycle information 704 and product builder interface 700 (FIG. 7) displays an expanded view of charge cycle information 704.

In this example, selection of fee control 818 causes product builder interface 800 to display fee portion 802 for entry of various fees to be assessed for the monthly charge cycle. Fee portion 802 displays fee information 804, 812, 814 that specify various types of fees that may be assessed for the monthly charge cycle. Fee information 804 specifies a monthly subscription fee. Fee information 812 specifies a contract termination fee. Fee information 814 specifies an activation fee. For each type of fee, a user may specify the frequency with which to assess the fee and the amount of the fee in various currencies.

For example, product builder interface 800 displays control 824 for removing the type of fee specified by fee information 804. Product builder interface 800 also displays control 822 for editing a name and description of the type of fee specified by fee information 804. Product builder interface 800 displays control 806 selecting a frequency with which to assess the fee specified by fee information 804. For example, the fee may be assessed at varying time intervals, including, e.g., monthly, quarterly, semi-annually, and so forth. Product builder interface 800 also displays pricing controls 808, 810 for specifying an amount for the fee represented by fee information 804. In this example, pricing control 808 enables a user to specify an amount of the fee in U.S. dollars. Pricing control 810 enables a user to specify an amount of the fee in Euros. Product builder interface 800 also displays usage model control 816, selection of which enables a user to associate a usage model with one or more products included in a plan. Based on the information selected through control 806 and the information entered by pricing controls 808, 810, product invoice template 102 is updated to display a visualization of the various fees in a simulated invoice.

In the example of FIG. 8, product builder interface 800 also includes finalization control 826 for generating a finalized product (and/or products) that is offered for sale (e.g., in a product catalog). In this example, upon selection of finalization control 826, the system generates two finalized products. A first finalized product is the plan represented by plan information 428 and invoiced according to charge cycle information 702 (e.g., a monthly charge cycle). A second finalized product is the plan represented by plan information 428 and invoiced according to charge cycle information 704 (e.g., an annual charge cycle). In an example, a user may select finalization control 826 following specifying various usage models, e.g., as described below.

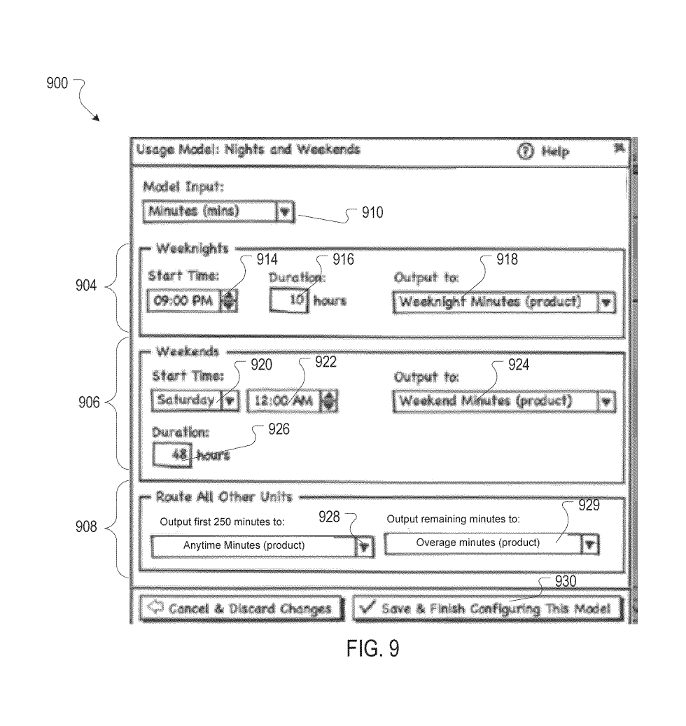

Referring to FIG. 9, product builder interface 900 is displayed, e.g., following selection of usage model control 816. In this example, product builder interface 900 may be displayed in the usage model stage and may be displayed as an overlay to product builder interface 800 (FIG. 8).

In the example of FIG. 9, product builder interface 900 enables a user to specify usage models for the products represented in a plan, including, e.g., the products represented by items 402, 404, 408, 410 of product information 422. In this example, product builder interface 900 includes model input control 910 for selection of an information type to be input into a usage model. There are various information types, including, e.g., an information type of minutes (as shown in FIG. 9), an information type of data bytes, and so forth.

Product builder interface 900 also includes usage model portions 904, 906, 908 for a user to define various usage models. In this example, usage model portion 904 enables a user to define a weeknight usage model for when consumer use of minutes is billed to the weeknight minutes product that is represented by item 404 of product information 422 (FIG. 8). Usage model portion 904 includes time control 914 for a user to input information specifying a start time for when minutes are billed to the weeknight minutes product that is represented by item 404 of product information 422 (FIG. 8). Usage model portion 904 includes duration control 916 for a user to input information specifying a duration of time for which minutes are billed to the weeknight minutes product that is represented by item 404 of product information 422 (FIG. 8). Usage model portion 904 also includes output control 918 for a user to select a product (e.g., the weeknight minutes product that is represented by item 404 of product information 422) to output the minutes that are used during the time period specified by time control 914 and duration control 916. By outputting minutes to a particular product, the system uses the pricing model of the particular product in invoicing a consumer.

In this example, usage model portion 906 enables a user to define a weekend usage model for when consumer use of minutes is billed to the weekend minutes product that is represented by item 408 of product information 422 (FIG. 8). Usage model portion 906 includes time control 920 for a user to input information specifying a day (e.g., Saturday) for when minutes are billed to the weekend minutes product that is represented by item 408 of product information 422 (FIG. 8). Usage model portion 906 includes time control 922 for a user to input information specifying a time (e.g., 12:00 AM) for when minutes are billed to the weekend minutes product that is represented by item 408 of product information 422 (FIG. 8). Usage model portion 904 includes duration control 926 for a user to input information specifying a duration of time for which minutes are billed to the weekend minutes product that is represented by item 408 of product information 422 (FIG. 8). Usage model portion 904 also includes output control 924 for a user to select a product (e.g., the weekend minutes product that is represented by item 408 of product information 422) to output the minutes that are used during the time period specified by time controls 920, 922 and duration control 926.

Product builder interface 900 includes usage model portion 908 for specifying a usage model for handling of overflow minutes. Generally, overflow minutes include minutes that are not output to particular usage models. In this example, overflow minutes are minutes that are not output to either the weeknight minutes product or the weekend minutes product. Usage model portion 908 includes output control 928 to specify that the first two-hundred fifty overflow minutes are applied to the anytime minutes product that is represented by item 402 of product information 422. Usage model portion 908 includes output control 929 to specify that the remaining overflow minutes are applied to the overage minutes product that is represented by item 410 of product information 422. In this example, the usage models specified by usage model portions 904, 906, 908 are applied to various charge cycles, including, e.g., the monthly charge cycle specified by charge cycle information 702 and the annual charge cycle specified by charge cycle information 704. Product builder interface 900 also includes control 930 for saving the specified usage models and applying them to the various charge cycles included in the plan represented by plan information 428 (FIG. 8).

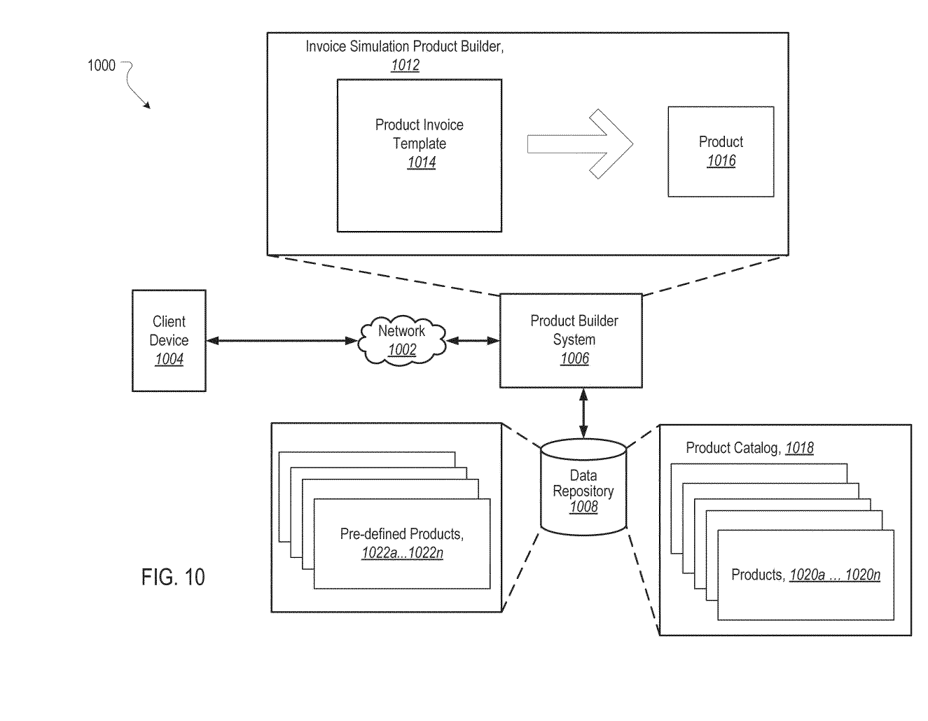

Referring to FIG. 10, network environment 1000 is configured to use invoice simulation product builder 1012 to generate product invoice template 1014. In this example, network environment 1000 includes network 1002, client device 1004, product builder system 1006 and data repository 1008. Product builder system 1006 includes a system that hosts invoice simulation product builder 1012 for generating (e.g., periodically and/or in real-time) product invoice templates.

In the example of FIG. 10, data repository 1008 stores items 1022a . . . 1022n of information that are indicative of various predefined products. For purposes of convenience, and without limitation, items 1022a . . . 1022n of information that are indicative of various predefined products may be referred to as predefined products 1022a . . . 1022n. Data repository 1008 also stores information 1018 representative of a product catalog. For purposes of convenience, and without limitation, information 1018 representative of a product catalog may be referred to as product catalog 1018. Generally, a product catalog includes a plurality of products and/or plans that are available for purchase by consumers. In this example, product catalog 1018 includes items 1020a . . . 1020n of information that are indicative of products that are available for a consumer to purchase. For purposes of convenience, and without limitation, items 1020a . . . 1020n of information that are indicative of products that are available for a consumer to purchase in product catalog 1018 are referred to as products 1020a . . . 1020n.

In the example of FIG. 10, a user of client device 1004 accesses invoice simulation product builder 1012 over network 1002. For example, the user may use a web browser on client device 1004 to access various product builder interfaces that are included in invoice simulation product builder 1012. Using invoice simulation product builder 1012 (and/or product builder interfaces accessed through invoice simulation product builder 1012), a user selects one or more of pre-defined products 1022a . . . 1022n to be included in product invoice template 1014. In this example, invoice simulation product builder 1012 batches the selected predefined products together into a plan that is represented in product invoice template 1014. Through invoice simulation product builder 1012, a user may configure one or more of pre-defined products 1022a . . . 1022n included in the plan of product invoice template 1014 (e.g., as previously described with regard to FIG. 5). For example, a user may edit a price (e.g., in various currencies) of a product included in product invoice template 1014. A user may also edit a type of unit to be associated with a product included in product invoice template 1014. Additionally, through invoice simulation product builder 1012, the user can also create brand new products from scratch within the invoice simulation product builder 1012. The use has the choice to either start with an existing template as a base or create something new, or a combination of both new and existing.

Through invoice simulation product builder 1012, a user may also specify one or more charge cycles to be applied to the plan represented by product invoice template 1014, e.g., as previously described with regard to FIG. 6. Through invoice simulation product builder 1012, a user may also specify one or more usage models to be applied to the plan represented by product invoice template 1014, e.g., as previously described with regard to FIG. 9.

Following configuration of the products included in product invoice template 1014 and the plan included in product invoice template 1014, invoice simulation product builder 1012 updates product invoice template 1014 to display a simulated invoice (not shown) for the products and the plan included in product invoice template 1014. After review of the products and the plan included in product invoice template 1014, a user of client device 1004 may finalize the products and plans included in product invoice template 1014 to generate product 1016 (e.g., a finalized product). In this example, product 1016 may include various plans and/or products that are offered for sale as a single product. In the example of FIG. 10, the user uses invoice simulation product builder 1012 to create objects that are stored in product catalog 1018. These created objects include products 1020a . . . 1020n, packages and bundles (not shown), usage and product models (not shown), fee information (not shown), and so forth.

In an example, product builder system 1006 generates product 1016 by adding the products and/or plans represented in product invoice template 1014 to product 1016. Product builder system 1006 associates each of the products and/or plans included in product 1016 with the appropriate charge model(s) specified in product invoice template 1014, the appropriate usage model(s) specified in product invoice template 1014 and with the appropriate pricing model(s) specified in product invoice template 1014.

For example, product builder system 1006 stores in data repository 1008 information indicative of product 1016. Product builder system 1006 adds the products and/or plans represented in product invoice template 1014 to product 1016 by generating associations, in data repository 1008, among the information indicative of product 1016 and information indicative of the products and/or plans represented in product invoice template 1014.

Product builder system 1006 associates each of the products and/or plans included in product 1016 with specified charge model(s) by generating, in data repository 1008, associations among the information indicative of the products and/or plans represented in product invoice template 1014 and information indicative of the specified charge model(s). Product builder system 1006 associates each of the products and/or plans included in product 1016 with specified usage model(s) by generating, in data repository 1008, associations among the information indicative of the products and/or plans represented in product invoice template 1014 and information indicative of the usage model(s). Product builder system 1006 associates each of the products and/or plans included in product 1016 with specified pricing model(s) by generating, in data repository 1008, associations among the information indicative of the products and/or plans represented in product invoice template 1014 and information indicative of the specified pricing model(s).

In the example of FIG. 10, data repository 1008 stores information indicative of product 1016. In this example, product 1016 may include one or more of a telephony product, a data product, and an internet product. In this example, product builder system 1006 may receive, from client computing device 1004, information indicative of a name of product 1016. In this example, product builder system 1006 assigns, in data repository 1008, the information indicative of the name of the product to the information that is indicative of product 1016.

Through invoice simulation product builder 1012 and/or another component of product builder system 1006, a user of client device 1004 may transmit to product builder system 1006 information specifying that product 1016 should be assigned to product catalog 1018. Following receipt of this information, product builder system 1006 generates in data repository 1008 an association between information indicative of product 1016 and product catalog 1018.

In a variation of FIG. 10, client device 1004 downloads invoice simulation product builder 1012 from product builder system 1006. In this example, client device 1004 locally accesses invoice simulation product builder 1012 to generate a product invoice template.

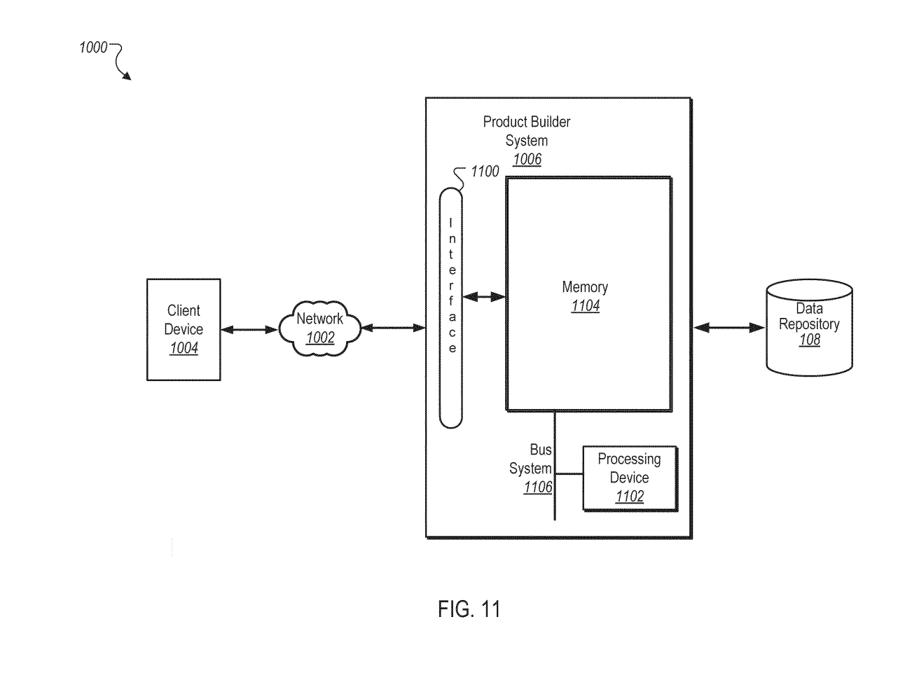

Referring to FIG. 11, product builder system 1006 can be a variety of computing devices capable of receiving data and running one or more services (e.g., an invoice simulation product builder), which can be accessed by client device 1004. In an example, product builder system 1006 can include a server, a distributed computing system, a desktop computer, a laptop, a cell phone, a rack-mounted server, any combination of the foregoing, and the like. Product builder system 1006 can be a single server or a group of servers that are at a same position or at different positions. Product builder system 1006 and client device 1004 can run programs having a client-server relationship to each other. Although distinct modules are shown in the figures, in some examples, client and server programs can run on the same device.

Product builder system 1006 can receive data from client device 1004 through input/output (I/O) interface 1100. I/O interface 1100 can be a type of interface capable of receiving data over a network, including, e.g., an Ethernet interface, a wireless networking interface, a fiber-optic networking interface, a modem, and so forth. Product builder system 1006 also includes a processing device 1102 and memory 1104. A bus system 1106, including, for example, a data bus and a motherboard, can be used to establish and to control data communication between the components of product builder system 1006.

Processing device 1102 can include one or more microprocessors. Generally, processing device 1102 can include an appropriate processor and/or logic that is capable of receiving and storing data, and of communicating over a network. Memory 1104 can include a hard drive and a random access memory storage device, including, e.g., a dynamic random access memory, or other types of non-transitory machine-readable storage devices. As shown in FIG. 11, memory 1104 stores computer programs (e.g., an invoice simulation product builder, which is not shown) that are executable by processing device 1102. These computer programs may include a data engine (not shown) for implementing the operations and/or the techniques described herein. The data engine can be implemented in software running on a computer device (e.g., product builder system 1006), hardware or a combination of software and hardware.

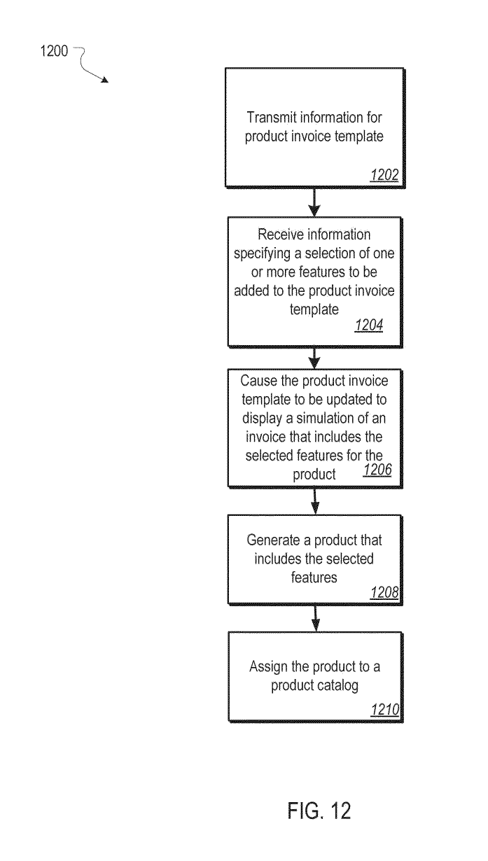

Referring to FIG. 12, product builder system 1006 (FIG. 10) (and/or invoice simulation product builder 1012 (FIG. 10)) implements process 1200 in using a product invoice template to generate a product. In operation, product builder system 1006 transmits (1202), to a client device, information for enabling user of the client device to access a product invoice template. In an example, the transmitted information includes information for generating (e.g., on a client device) various product builder interfaces that are included in an invoice simulation product builder. Product builder system 1006 receives (1204), from the client device, information specifying a selection of one or more features to be added to the product invoice template. In this example, the selected features may include various products to be included in the product invoice template, an instruction to generate a multi-feature product (e.g., a plan) in the product invoice template from the included products, information specifying types of charge cycles to the applied to the plan represented in the product invoice template, information specifying a usage model to be applied to various products and/or plans in the product invoice template, information specifying fees to be applied to various products and/or plans in the product invoice template, information specifying types of pricing models to be applied to various products and/or plans in the product invoice template, and so forth.

In the example of FIG. 12, product builder system 1006 causes (1206) the product invoice template to be updated to display a simulation of an invoice that includes the selected features (e.g., for the product that is generated through product builder system 1006). In this example, a user may view the simulated invoice and approve the selected features, e.g., by sending to product builder system 1006 instructions specifying that the features shown in product invoice template are to be finalized into a product that may be added to a product catalog.

In this example, product builder system 1006 generates (1208) a product that includes the approved features included in the product invoice template. Product builder system 1006 generates the product by adding, in a data repository, information indicative of the approved features to information indicative of the generated product (e.g., a name of the generated product). A user may also submit to product builder system 1006 instructions specifying one or more product catalogs to which the generated product is assigned. Following receipt of these instructions, product builder system 1006 assigns (1210) the generated product to the one or more specified product catalogs.

Embodiments can be implemented in digital electronic circuitry, or in computer hardware, firmware, software, or in combinations thereof. Apparatus of the techniques described herein can be implemented in a computer program product tangibly embodied or stored in a machine-readable media (e.g., storage device) for execution by a programmable processor; and method actions can be performed by a programmable processor executing a program of instructions to perform operations of the techniques described herein by operating on input data and generating output. The techniques described herein can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A method comprising:
accessing, by a server computing device, information indicative of an invoice simulation product builder for generating a product, with the invoice simulation product builder comprising a plurality of graphical user interfaces, with at least one of the graphical user interfaces, when rendered on a display device, comprising:
a visual representation of a product invoice template for the product being generated with the invoice simulation product builder, with the invoice simulation product builder promoting generation of the product by adding one or more features to the product invoice template, and with the product invoice template comprising a simulation of an invoice for the product being generated with the invoice simulation product builder;
transmitting, to a client computing device, the information indicative of the invoice simulation product builder;
receiving, from the client computing device, information indicative of a selection in the product invoice template of features of the product;
causing the product invoice template to be updated to display a simulation of an invoice that includes the selected features for the product; and
adding the selected features to the product.

2. The method of claim 1, wherein a first one of the features comprises a predefined product that is offered for sale; and
wherein a second one of the features comprises one or more of a charge model, wherein the charge model comprises one or more of:
a recurring charge model; and
a one-time charge model;
wherein a third one of the features comprises:
a usage model for the predefined product, with a usage model specifying one or more instructions for detecting when consumer use of a product is billed to the predefined product; and
wherein a fourth one of the features comprises:
a pricing model for the predefined product, with the pricing model comprising information indicative of an amount charged for use of a product included in the predefined product.

3. The method of claim 2, wherein adding the selected features to the product comprises:
adding the predefined product to the product that is generated with the invoice simulation product builder;
adding the charge model to the product that is generated with the invoice simulation product builder;
generating an association between the predefined product and the charge model;
adding the usage model to the product that is generated with the invoice simulation product builder;
generating an association between the predefined product and the usage model;
adding the pricing model to the product that is generated with the invoice simulation product builder; and
generating an association between the predefined product and the pricing model.

4. The method of claim of claim 3, further comprising:
receiving, from the client computing device, information indicative of one or more modifications to the pricing model for the predefined product; and
updating the pricing model for the predefined product that is included in the product that is generated with the invoice simulation product builder, with updating being in accordance with the one or more modifications.

5. The method of claim 1, further comprising:
receiving, from the client computing device, information indicative of a name of the product that is generated with the invoice simulation product builder;
assigning, in a data repository, the information indicative of the name of the product to information that identifies the product.

6. The method of claim 1, further comprising:
storing, in a data repository, information indicative of the product that is generated with the invoice simulation product builder.

7. The method of claim 1, further comprising:
assigning information indicative of the product that is generated with the invoice simulation product builder to information indicative of a product catalog, with a product catalog comprising at least a plurality of products that are available for purchase by one or more consumers.

8. The method of claim 1, wherein the product that is generated with the invoice simulation product builder comprises one or more of:
a telephony product, a data product, and an internet product.

9. One or more machine-readable storage media storing instructions that are executable by one or more processing devices to perform operations comprising:
accessing information indicative of an invoice simulation product builder for generating a product, with the invoice simulation product builder comprising a plurality of graphical user interfaces, with at least one of the graphical user interfaces, when rendered on a display device, comprising:
a visual representation of a product invoice template for the product being generated with the invoice simulation product builder, with the invoice simulation product builder promoting generation of the product by adding one or more features to the product invoice template, and with the product invoice template comprising a simulation of an invoice for the product being generated with the invoice simulation product builder;
transmitting, to a client computing device, the information indicative of the invoice simulation product builder;
receiving, from the client computing device, information indicative of a selection in the product invoice template of features of the product;
causing the product invoice template to be updated to display a simulation of an invoice that includes the selected features for the product; and
adding the selected features to the product.

10. The one or more machine-readable storage media of claim 9, wherein a first one of the features comprises a predefined product that is offered for sale; and
wherein a second one of the features comprises one or more of a charge model, wherein the charge model comprises one or more of:
a recurring charge model; and
a one-time charge model;
wherein a third one of the features comprises:
a usage model for the predefined product, with a usage model specifying one or more instructions for detecting when consumer use of a product is billed to the predefined product; and
wherein a fourth one of the features comprises:
a pricing model for the predefined product, with the pricing model comprising information indicative of an amount charged for use of a product included in the predefined product.

11. The one or more machine-readable storage media of claim 10, wherein adding the selected features to the product comprises:
adding the predefined product to the product that is generated with the invoice simulation product builder;
adding the charge model to the product that is generated with the invoice simulation product builder;
generating an association between the predefined product and the charge model;
adding the usage model to the product that is generated with the invoice simulation product builder;
generating an association between the predefined product and the usage model;
adding the pricing model to the product that is generated with the invoice simulation product builder; and
generating an association between the predefined product and the pricing model.

12. The one or more machine-readable storage media of claim 11, wherein the operations further comprise:
receiving, from the client computing device, information indicative of one or more modifications to the pricing model for the predefined product; and
updating the pricing model for the predefined product that is included in the product that is generated with the invoice simulation product builder, with updating being in accordance with the one or more modifications.

13. The one or more machine-readable storage media of claim 9, wherein the operations further comprise:
receiving, from the client computing device, information indicative of a name of the product that is generated with the invoice simulation product builder;
assigning, in a data repository, the information indicative of the name of the product to information that identifies the product.

14. The one or more machine-readable storage media of claim 9, wherein the operations further comprise:
assigning information indicative of the product that is generated with the invoice simulation product builder to information indicative of a product catalog, with a product catalog comprising at least a plurality of products that are available for purchase by one or more consumers.

15. A system comprising:
one or more processing devices; and
one or more machine-readable storage media storing instructions that are executable by the one or more processing devices to perform operations comprising:
accessing information indicative of an invoice simulation product builder for generating a product, with the invoice simulation product builder comprising a plurality of graphical user interfaces, with at least one of the graphical user interfaces, when rendered on a display device, comprising:
a visual representation of a product invoice template for the product being generated with the invoice simulation product builder, with the invoice simulation product builder promoting generation of the product by adding one or more features to the product invoice template, and with the product invoice template comprising a simulation of an invoice for the product being generated with the invoice simulation product builder;
transmitting, to a client computing device, the information indicative of the invoice simulation product builder;
receiving, from the client computing device, information indicative of a selection in the product invoice template of features of the product;
causing the product invoice template to be updated to display a simulation of an invoice that includes the selected features for the product; and
adding the selected features to the product.

16. The system of claim 15, wherein a first one of the features comprises a predefined product that is offered for sale; and
wherein a second one of the features comprises one or more of a charge model, wherein the charge model comprises one or more of:
a recurring charge model; and
a one-time charge model;
wherein a third one of the features comprises:
a usage model for the predefined product, with a usage model specifying one or more instructions for detecting when consumer use of a product is billed to the predefined product; and
wherein a fourth one of the features comprises:
a pricing model for the predefined product, with the pricing model comprising information indicative of an amount charged for use of a product included in the predefined product.

17. The system of claim 16, wherein adding the selected features to the product comprises:
adding the predefined product to the product that is generated with the invoice simulation product builder;
adding the charge model to the product that is generated with the invoice simulation product builder;
generating an association between the predefined product and the charge model;
adding the usage model to the product that is generated with the invoice simulation product builder;
generating an association between the predefined product and the usage model;
adding the pricing model to the product that is generated with the invoice simulation product builder; and
generating an association between the predefined product and the pricing model.

18. The system of claim 17, wherein the operations further comprise:
receiving, from the client computing device, information indicative of one or more modifications to the pricing model for the predefined product; and
updating the pricing model for the predefined product that is included in the product that is generated with the invoice simulation product builder, with updating being in accordance with the one or more modifications.

19. The system of claim 16, wherein the operations further comprise:
receiving, from the client computing device, information indicative of a name of the product that is generated with the invoice simulation product builder;
assigning, in a data repository, the information indicative of the name of the product to information that identifies the product.

20. The system of claim 16, wherein the operations further comprise:
assigning information indicative of the product that is generated with the invoice simulation product builder to information indicative of a product catalog, with a product catalog comprising at least a plurality of products that are available for purchase by one or more consumers.
